(19) United States
(12) Patent Application Publication
(10) Pub. No.: US 2002/0180111 A1
(43) Pub. Date: Dec. 5, 2002

(54) Method and installation for producing a film made of a thermoplastic material

(76) Inventors: Klaus Steinberg, Troisdorf (DE); Friedhelm Ebert, Konigswinter (DE)

Correspondence Address: Pauley Petersen Kinne & Erickson, 2800 W. Higgins Road, Suite 365, Hoffman Estates, IL, 60195, US

(21) Appl. No.: 10/101,547

(22) Filed: Mar. 18, 2002

(30) Foreign Application Priority Data
Mar. 17, 2001 (DE) 101 13 089.9

(51) Int. Cl. B29C 47/92

(52) U.S. Cl. 264/466; 425/174.8 E

(57) ABSTRACT

A method and an installation for producing a film made of a thermoplastic material, wherein the plastic material emerges from a blow head of an extruder while forming a film bubble. The film bubble is sized to a predetermined diameter by the action of a sizing device and is subsequently laid flat by a flattening device and is rolled up. To prevent damage to the surface of the film bubble, there is an electrostatic charge to the plastic material forming the film bubble prior to entry into the sizing device. The film bubble is conducted through a sizing device, which is electrostatically charged in the same way, to provide a contact-free sizing of the film bubble.

### BACKGROUND OF THE INVENTION

1. Field of the Invention

This invention relates to a method for producing a film made of a thermoplastic material, wherein the plastic material exits from a blow head of an extruder while forming a film bubble, the film bubble subsequently passes through a sizing device, in which it is sized to a predetermined diameter, and wherein subsequently the film bubble is laid flat by a flattening device and thereafter is wound up. This invention also relates to an installation for producing a film from a thermoplastic material, including an extruder with a blow head from which a plastic film bubble exits, a sizing device acting on the exterior of the film bubble, and a flattening device arranged downstream of the sizing device.

2. Description of Related Art

A production method for making films, also called blown film, from a thermoplastic material is known.

A plastic material exits from the usually ring-shaped opening of the blow head in a thermoplastic molten state and is immediately blown to form a film bubble, which subsequently solidifies during cooling below the solidification temperature. The film bubble is passed through a sizing device and its diameter is sized, and then it is laid flat by a flattening device to form a double-film web, and thereafter it is wound up.

Usually the sizing device is formed as a sizing basket which surrounds the film bubble on the outside and has a plurality of sizing arms, which contact the outside of the circumference of the film bubble in order to fix and size its diameter. For example, the sizing arms can have a multitude of rotatable plastic rollers, which roll off onto the surface of the film bubble and simultaneously size it. Embodiments with rotating brushes or the like are also known.

All these methods are distinguished because when passing through the sizing device the film bubble contacts the sizing means, for example the sizing arms and the plastic rollers fastened on them, so that a direct contact takes place. This contact of the film, which is not yet completely cooled and solidified in the area of the sizing device, with the sizing device is disadvantageous, for example during production of highly transparent films, because respective running marks can be formed on the surface of the film due to contact friction, which later negatively affect the visual appearance of the produced film.

A sizing of the film bubble which is as contact-free as possible can therefore be advantageous in certain applications.

According to European Patent Reference EP 0 273 739, the film bubble is guided in a contact-free manner between strong air flows acting on the inside and outside of the film bubble in order to avoid contact friction, along with a resulting marring of the surface of the film bubble. However, the installation cost for high-performance blowers, air conduits, as well as the appropriate control technology required for this, is great. There is also a problem because too strong air currents cause undesired temperature effects in the film bubble, which negatively affect the quality of the obtained film.

### SUMMARY OF THE INVENTION

One object of this invention is to provide a method for producing a film made of thermoplastic material, wherein a contact-free sizing of the film bubble occurs in the simplest way possible.

For attaining this object, a method in accordance with the claims and this specification is proposed, wherein a plastic material forming the film bubble has an electric charge prior to entering the sizing device and is electrostatically charged. Also, the sizing device has an electrical charge of the same potential so that the film bubble passes through the sizing device without being touched.

It is a further object of this invention to suggest an installation for producing a film made of thermoplastic material.

This object is attained by means of an installation in accordance with the claims and this specification.

The films of thermoplastic material which can be produced by the method of this invention have one useful property because they can be electrostatically charged in a well controlled manner during their passage through a sufficiently strong electrical field and maintain this electrostatic charge over a defined period of time, where this invention starts.

Because the thermoplastic material forming the film bubble is electrostatically charged prior to cooling to below the solidification temperature and prior to entering the sizing device, it is possible to pass it through the sizing device in a contact-free manner if the sizing device is electrically charged with the same potential. The repulsive forces between the electrically charged film bubble and the sizing device being created in the process are sufficient to exert radial forces on the film bubble in order to size its exterior to its desired diameter, but at the same time prevent the film bubble from contacting the parts of the sizing device charged with the same potential. Interfering markings, grooves, damages and the like of the surface of the film bubble during passage through the sizing device are prevented in a simple manner.

Depending on the type of the film produced by the method of this invention and the degree of the forces which must be applied to the exterior for sizing, the electrostatic charge of the sizing basket, or of the sizing device, is appropriately adjusted with respect to the electrostatic charge of the plastic material forming the film bubble, to provide a contact-free passage of the film bubble through the sizing device.

Advantageous embodiments and further developments of the method of the invention are the subject of the claims and this specification.

Charging the plastic material forming the film bubble prior to entering the sizing device can occur in two different ways.

It is possible to electrostatically charge the plastic material after exiting the blow head and prior to entering the sizing device. After exiting the blow head, the film bubble passes through an appropriate electrical field oriented transversely with respect to the movement direction, or spreading direction, of the film bubble.

Similarly, it is possible for the plastic material to be already electrostatically charged prior to exiting the blow head, for which purpose an electrical field is generated inside the melt conduits of the blow head transversely to the spreading direction of the plastic material, which electrically charges the plastic material in a desired manner.

In another embodiment of this invention the flattening device, which flattens the film bubble into a double-film web after passing through the sizing device, can also be charged with an electrical charge of the same potential as the plastic material and the sizing device, so that the film bubble can also pass through the flattening device in a contact-free manner, and also no damage of the surface of the film bubble can occur in this area.

Depending on individual process parameters, the electrical charge of the plastic material forming the film bubble prior to entry into the sizing device can be already sufficient to also assure the contact-free guidance of the film bubble inside the flattening device.

If not, in accordance with a further embodiment of this invention, following passage through the sizing device and prior to reaching the flattening device, the film bubble is again provided with an electrical charge and is electrostatically charged. To this end, the film bubble can pass through an appropriate electrical field between the sizing device and the flattening device, so that it is again electrostatically charged in a desired way.

The electrostatic charging of the plastic material can be advantageously performed in a gap between two electrodes, one of which is arranged in the interior of the film bubble, and the other surrounds the film bubble in a ring shape on the outside while forming a gap for the passage of the film bubble. Both electrodes have a difference in electrical potential which is sufficient for electrostatically charging of the plastic material, so that the electrical field required for the electrostatic charging can be generated transversely relative to the spreading direction of the film bubble.

It is also possible to create an electrostatic charge of the plastic material with spray electrodes, wherein a positive, as well as a negative charge, can be considered in all cases.

For achieving the desired contact-free guidance of the film bubble in the sizing device, the installation for producing a film made of a thermoplastic material and being operated in accordance with the method of claims this invention has a charging device for the plastic material which is arranged upstream of the sizing device and has two parts, between which a gap for the passage of the plastic material is formed. The installation in accordance with this invention comprises a high voltage source with a connection to an electrical network, voltage regulators and rectifiers, for generating a pulsed d.c. current, wherein one pole of the high voltage source is connected to an element of the charging device which is seated in an insulated manner, and to the sizing device. It is then possible to generate the desired electrical field in the charging device, for example by connecting the further element of the charging device to ground, which electrostatically charges the plastic material forming the film bubble while passing through the charging device in the desired manner. The sizing device is connected with the same pole of the high voltage source and therefore has the same potential as the electrostatically charged film bubble, so that the desired repulsion between the film bubble and the sizing device is achieved and the film bubble passes contact-free through the sizing device while its diameter is sized in the desired way at the same time.

The charging device explained above can be arranged between the blow head and the sizing device in the movement direction of the film bubble, or also inside the blow head.

In an advantageous manner, the sizing device includes a plurality of metal segments bent in a bow-shaped manner, which are arranged along a circle surrounding the circumference of the film bubble, and can be charged with the d.c. current from the high voltage source, so that the desired forces can be transferred by the sizing device in a contact-free manner over the entire circumference of the film bubble in the area of passage through the sizing device, without a contact friction being generated between the film bubble and the sizing device.

In a further embodiment of the installation in accordance with this invention, it is possible to connect the part of the charging device which is seated electrically insulated, the sizing head, as well as the flattening device, with the same pole of the high voltage source, so that with the electrostatic charge of the film bubble and the charge of the flattening device with the same electrical potential a contact-free guidance of the film bubble is assured in the area of the flattening device.

If the charge device provided upstream of the entry of the film bubble into the sizing device is insufficient to electrostatically charge the film bubble for a contact-free passage through the flattening device, a further charging device for the film bubble can be provided, viewed in the movement direction of the film bubble, between the sizing device and the flattening device.

### BRIEF DESCRIPTION OF THE DRAWINGS

Further embodiments and details of this invention are explained in view of the drawings, wherein:

FIG. 1 is a schematic representation of an installation for producing a film in the area of a blow head, and of the sizing device,

FIG. 2 is a schematic representation of a further embodiment of an installation for producing a film in the area of the flattening device.

### DESCRIPTION OF PREFERRED EMBODIMENTS

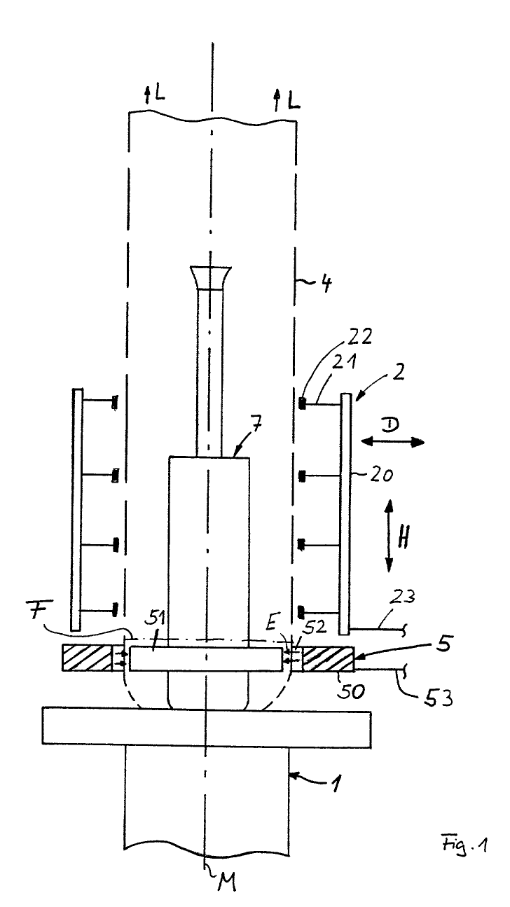

The installation for producing a film made of a thermoplastic material, represented in FIG. 1, comprises a blow head 1, not represented in great detail, which is charged with molten thermoplastic material from an extruder, not shown. In a known manner, the plastic material exits in the thermoplastic state from the blow head 1 through an upper annular outlet opening and is immediately blown up into a film bubble 4 and vertically removed in the direction of the arrow L. The film bubble has a circular cross section with a center axis M.

Immediately following its exit from the blow head 1, the plastic material forming the film bubble 4 is still in the thermoplastic state because of its high temperature, but it cools rapidly to below its solidification point, so that the film bubble 4 is changed into a solidified state. The transition between the thermoplastic state and the solidified state of the film bubble 4 is shown by a so-called frost line F, shown in FIG. 1.

Furthermore, the interior air exchanger 7 used to support the film bubble 4 and arranged in a known manner in the interior of the film bubble 4, is also shown in FIG. 1.

A charging device 5, through which the film bubble 4 passes, is provided closely above the blow head 1 and still below the frost line F of the film bubble 4, such as in the area in which the plastic material forming the film bubble 4, which exits from the blow head 1, is in the thermoplastic state.

The charging device 5 has two elements, an inner ring 51 arranged in the interior of the film bubble 4, and an outer ring 50, which is arranged all around the inner ring 51, leaving an annular passage gap 52, through which the film bubble 4 passes.

The outer ring 50 is connected via a connecting line 53 with a high voltage source which is connected to the electrical network, not shown, a voltage regulator and a rectifier for generating a pulsed d.c. current at one pole, so that the outer ring 50 can be charged with the pulsed d.c. current provided by the high voltage source.

The outer ring 50 is supported electrically insulated relative to the further elements of the installation in a manner not shown in detail.

In contrast to this, the inner ring 51 is grounded, for example, so that an electrical field E is generated between the outer ring 50 and the inner ring 51, which extends transversely, in particular perpendicularly to the movement direction L of the film bubble 4, and through which the film bubble 4 passing through the passage gap 52 passes transversely relative to its movement direction L.

Because of the difference in potential between the outer ring 50 and the inner ring 51 and because of the generated electrical field E, the plastic material forming the film bubble 4 is electrostatically charged in a desired manner when passing through the charging device 5. It is possible here to create a positive, as well as a negative charge of the film bubble 4, and the size of this charge can also be individually set by an appropriate control and regulation of the high voltage source connected via the connecting line 53 to the charging device 5. The film bubble 4, thus electrostatically charged enters, after the charging device 5 and above its frost line F, for example in the solidified state, a sizing device 2, in which the diameter of the film bubble 4 is sized.

Thus the sizing device 2 has a sizing basket 20, which surrounds the film bubble 4 on its circumference, on whose inside a plurality of support arms 21 are arranged in the direction toward the film bubble 4 passing through the sizing device 2. On their free ends adjoining the film bubble 4, the support arms 21 each have metal segments 22, whose number and arrangement is only schematically shown in FIG. 1. Metal segments 22 bent in a bow-like shape are preferably provided, which are arranged in a segment-like manner on a common circle surrounding the film bubble 4, so that they can act on the largest possible areas of the circumferential surface of the film bubble 4 during its passage through the sizing device 2.

The sizing device 2 is also connected via a connecting line 23 with the high voltage source, the same as with the charging device 5 via the connecting line 53. Therefore the same electrical potential is applied to the sizing device 2 as to the charging device 5 and to the film bubble 4 charged by the charging device 5.

This electrical potential acts through the metal segments 22, which are positioned in close proximity to the surface of the film bubble 4, and which is electrostatically charged with the same potential, so that repulsive forces appear between the sizing device and the film bubble 4.

For one, these repulsive forces are responsible for the desired sizing of the film bubble 4 to its desired diameter, and simultaneously a direct contact between the surface of the film bubble 4 and the metal segments 22 of the sizing device 2 is prevented, so that the film bubble 4 is sized during its passage through the sizing device 2 in a contact-free manner. Undesired markings by the sizing device 2 and/or damage of the surface of the film bubble 4 are therefore dependably prevented.

In order to be able to adapt the sizing device 2 to the respective production parameters, it is adjustable in a known manner in height in accordance with the arrow H and in its diameter in accordance with the arrow D.

It is possible by an appropriate variation of the electrical voltage with which the sizing device 2 is charged via the connecting line 23, to individually determine the force acting on the film bubble 4, which is electrostatically charged in the same way, oriented radially in the direction toward the center axis M for sizing the film bubble, as well as the distance between the metal segments 22 and the surface of the film bubble 4 arising as a result of the repulsive forces.

As a result a film bubble 4 is obtained, which is sized in a contact-free manner because of the charge by means of the charging device 5, and which has an exterior diameter sized by the sizing device 2 having the same electrical potential.

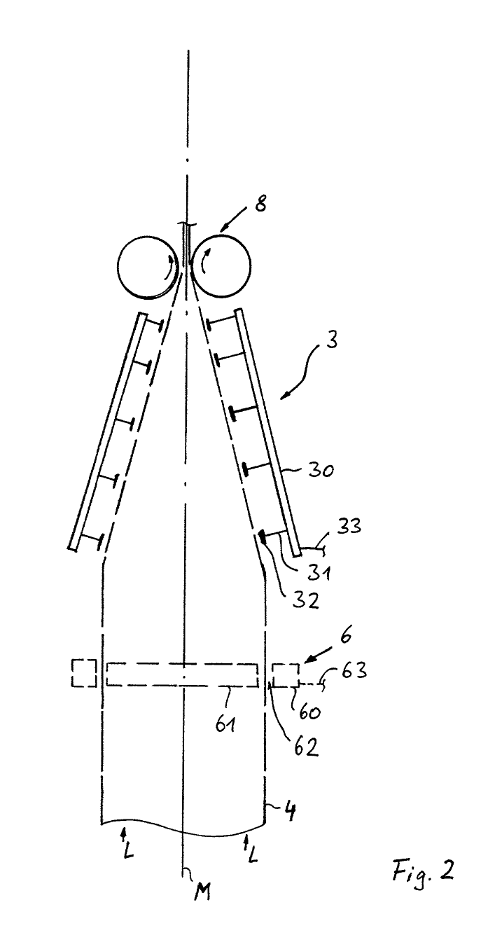

FIG. 2 shows a further development of the installation of the invention, which can be selectively provided in addition to the embodiment in accordance with FIG. 1, and which is connected above the sizing device 2.

First, in the lower area of FIG. 2 the film bubble 4 is shown, which has already passed through the sizing device 2 in FIG. 1 and continues in the vertical direction along the center axis M in the movement direction in accordance with the arrows L. After sufficient cooling of the sized film bubble 4, the film bubble 4 is laid flat by means of a flattening device 3, which is only shown schematically in FIG. 2, to form a double-film web, and is drawn through a pair of draw-off rollers 8, after which it is conducted to a draw-off and winding device, not shown in detail.

The same as with the sizing device 2, the flattening of the film bubble 4 in the flattening device 3 also occurs in a contact-free manner.

For this purpose the flattening device 3 has a support frame 30, on a side facing the surface of the film bubble 4 a multitude of support arms 31 are arranged, each of which has metal segments 32 on its free end adjoining the film bubble 4. The flattening device 3 is also connected via a connecting line 33 to an electrical high voltage source and can be charged with a pulsed d.c. current generated by the high voltage source.

For this purpose the same electrical potential is applied to the metal segments 32 of the flattening device 3 which also corresponds to the film bubble 4, electrically charged by the charging device 5.

Again an electrostatically caused repulsive effect is provided because of the same potential between the film bubble 4 and the flattening device 3, so that the film bubble 4 is conducted in a contact-free manner over the metal segments 32 of the flattening device 3, is laid flat into the desired double-film web and is subsequently drawn off through the pair of draw-off rollers 8. Thus a direct contact, and the creation of a contact friction between the flattening device 3 and the surface of the film bubble 4, is also prevented within the flattening device 3.

In the case where, after the passage through the sizing device 2, the electrostatic charge of the film bubble 4 generated in the charging device 5 is no longer sufficient for also providing the previously described contact-free flattening in the flattening device 3, it is possible as shown in FIG. 2 to provide a further charging device 6 between the sizing device 2 and the flattening device 3, viewed in the movement direction L of the film, which analogously to the charging device 5 comprises an inner ring 61 in the interior of the film bubble 4 and an outer ring 60, enclosing the inner ring 61 while leaving an annular passage gap 62 open. In this case the film bubble 4 is again passed through the passage gap 62, and the outer ring 60, which is supported in an electrically insulated manner, can be charged with the electrical voltage of the same potential from the high voltage source via a connecting line 63, so that when passing through the charging device 6 the film bubble 4 can again be electrostatically charged in a manner analogous to the charging device 5 in order to assure the contact-free flattening in the flattening device 3.

The components described above in view of the drawings are an example and are only represented purely schematically, in particular with respect to their arrangement and number.

The flattening device 4 in particular is shown only in a schematic and greatly simplified manner, wherein in particular the representation of auxiliary inlet guide devices, as well as lateral guides, for the film bubble 4 is omitted. However, these can be electrostatically charged in the same way in order to act contact-free on the film bubble 4.

So-called spray electrodes, suitable for the electrostatic charging of plastic films, can be used in place of the charging device 5 and/or 6 with inner rings and outer rings.

What is claimed is:

1. In a method for producing a film made of a thermoplastic material, wherein the thermoplastic material exits from a blow head of an extruder while forming a film bubble, and wherein the film bubble subsequently is passed through a sizing device, in which the film bubble is sized to a predetermined diameter, and wherein the film bubble is then laid flat by a flattening device and then is wound up, the improvement comprising: providing the thermoplastic material forming the film bubble with an electric charge prior to the film bubble entering the sizing device and is electrostatically charged, and providing the sizing device with an electrical charge of a same potential so that the film bubble passes through the sizing device without contact.

2. In the method in accordance with claim 1, wherein following exit from the blow head, the plastic material is electrostatically charged.

3. In the method in accordance with claim 1, wherein prior to exit from the blow head, the plastic material is electrostatically charged inside the blow head.

4. In the method in accordance with claim 3, wherein the flattening device is charged with an electrical charge of the same potential as the plastic material and the sizing device, so that the film bubble passes contact-free through the flattening device.

5. In the method in accordance with claim 4, wherein the plastic material forming the film bubble is again charged with an electrical charge and electrostatically charged following passage through the sizing device and prior to reaching the flattening device.

6. In the method in accordance with claim 6, wherein the plastic material forming the film bubble passes through a gap formed between two electrodes, wherein the electrodes have a potential difference electrostatically charging the plastic material.

7. In an installation for producing a film made of thermoplastic material, comprising an extruder with a blow head for emergence of a film bubble made of the plastic material, a sizing device acting on an exterior of the film bubble, a flattening device for the film bubble arranged downstream of the sizing device, the improvement comprising: a charging device for the plastic material arranged upstream of the sizing device, the charging device having two elements between which a gap for passage of the plastic material is formed, a high voltage source with a connection to the electrical network, a voltage regulator and a rectifier for generating of pulsed d.c. current and having one pole connected to an insulatingly seated element of the charging device and to the sizing device.

8. In the installation in accordance with claim 7, wherein when viewed in a movement direction of the film bubble, the charging device is arranged between the blow head and the sizing device.

9. In the installation in accordance with claim 7, wherein the charging device is arranged inside the blow head.

10. In the installation in accordance with claim 9, wherein the sizing device comprises a plurality of metal segments, which are bent in a shape of a bow, are arranged along a circle surrounding a circumference of the film bubble, and are charged with d.c. current from the high voltage source.

11. In the installation in accordance with claim 10, wherein a seated element of the charging device, a sizing basket and the flattening device are connected with a same pole of the high voltage source.

12. In the installation in accordance with claim 11, wherein in the movement direction of the film bubble, a further charging device for the film bubble is provided between the sizing device and the flattening device.

13. In the installation in accordance with claim 7, wherein the sizing device comprises a plurality of metal segments, which are bent in a shape of a bow, are arranged along a circle surrounding a circumference of the film bubble, and are charged with d.c. current from the high voltage source.

14. In the installation in accordance with claim 7, wherein a seated element of the charging device, a sizing basket and the flattening device are connected with a same pole of the high voltage source.

15. In the method in accordance with claim 1, wherein the flattening device is charged with an electrical charge of the same potential as the plastic material and the sizing device, so that the film bubble passes contact-free through the flattening device.

16. In the method in accordance with claim 1, wherein the plastic material forming the film bubble passes through a gap formed between two electrodes, wherein the electrodes have a potential difference electrostatically charging the plastic material.
